(19) United States
(12) Patent Application Publication
(10) Pub. No.: US 2005/0051732 A1
(43) Pub. Date: Mar. 10, 2005

(54) Radiation detecting device for use with a furnace

(76) Inventor: Francois Eberhardt Du Plessis, Stellenbosch (ZA)

Correspondence Address: STITES & HARBISON PLLC, 1199 NORTH FAIRFAX STREET, SUITE 900, ALEXANDRIA, VA, 22314, US

(21) Appl. No.: 10/497,970

(22) PCT Filed: Dec. 11, 2002
(86) PCT No.: PCT/ZA02/00203

(30) Foreign Application Priority Data
Dec. 11, 2001 (ZA) 2001/10197

(51) Int. Cl. G01T 1/00

(52) U.S. Cl. 250/394

(57) ABSTRACT

A device (24) for determining the conditions in a furnace is disclosed. The device comprises a gamma ray detector (28) within a shield (26) which blocks stray gamma rays. A tube (32) and a series of plates (34) form a path along which gamma rays emanating from a zone of the furnace at which the tube is pointed can pass to reach the detector (28). The output signal of the detector (28) is computer analysed to detect significant changes in the characteristics of the gamma rays reaching the detector (28). The device can be on mounting means permitting both horizontal and vertical motion thereby to permit interfaces between materials and also “banks” to be detected.

### FIELD OF THE INVENTION

THIS INVENTION relates to a radiation detecting device for use in conjunction with a furnace.

### BACKGROUND TO THE INVENTION

During mineral smelting and reduction processes in a furnace, important parameters are the levels of the interfaces between the various constituents, such as slag and molten metals, and between the top constituent and the hot gasses. These parameters are used by the furnace operator for control of the smelting and tapping process. Determination of the levels of these interfaces is, however, difficult due to, for example, the temperatures prevailing in the furnace and the strong electrical and magnetic fields. The physical nature of the containment vessel, consisting as it does of metal walls, firebrick linings and often water flowing over the outside of the vessel, also contributes to making determination of these levels difficult. All these factors prevent the levels of the interfaces being detected by safe and simple procedures.

The present invention provides a method of and apparatus for detecting these levels.

### BRIEF DESCRIPTION OF THE INVENTION

According to one aspect of the present invention there is provided a radiation detecting device for determining the conditions subsisting within a furnace, the device comprising gamma ray sensitive means for producing an output signal which varies in dependence on the characteristics of the gamma rays which said gamma ray sensitive means senses, means defining a path along which gamma rays emanating from a predetermined zone of said furnace can pass and impinge on said gamma ray sensitive means, and a shield for blocking gamma rays travelling towards said gamma ray sensitive means other than along said path.

In the preferred form the path defining means includes a plurality of horizontal, spaced apart, parallel plates within a tube.

Said gamma ray sensitive means can be a gamma ray spectrometer or a gamma ray radiation counter.

It is also possible for said gamma ray sensitive means to comprise a gamma ray spectrometer and a gamma ray radiation detector.

According to a further aspect of the present invention there is provided a system for determining the conditions subsisting within a furnace, the system comprising a plurality of devices as described above.

According to a still further aspect of the present invention there is provided a system comprising three devices as described above, the devices being spaced apart in the vertical direction, the top and bottom devices being fixed and providing reference signals, and the centre one being movable vertically and providing said output signal.

The present invention also provide, in combination, a device as described above and a mounting means for the device, the device being movable vertically on the mounting means. The mounting means can be mobile and can move horizontally with respect to the furnace. In one form of this combination the device is mounted so that it can move horizontally on the mounting means.

According to another aspect of the present invention there is provided, in combination, a device as described above and a computer programmed to receive and analyse said output signal and produce a reading indicative of a change in the characteristics of the gamma rays impinging on said gamma ray sensitive means.

According to yet another aspect of the present invention there is provided a method of determining the conditions subsisting within a furnace, the method comprising permitting gamma rays emanating from a predetermined zone of said furnace to impinge on a gamma ray sensitive means and generate an output signal which varies with the characteristics of the gamma rays impinging thereon, blocking gamma rays travelling towards said means other than from said zone, and analysing said output signal to detect changes in the characteristics of said gamma rays.

Preferably said zone is elongate in the horizontal direction and narrow in the vertical direction.

The method can comprise the further step of moving said gamma ray sensitive means vertically with respect to the furnace thereby to vary the position of said zone for the purpose of detecting interfaces between materials in the furnace.

For the purpose of determining the thickness of banks in the furnace the method can comprise moving said means horizontally with respect to the furnace thereby to vary the position of said zone.

In a specific form the method includes the steps of taking reference readings from upper and lower gamma ray sensitive means, moving an intermediate gamma ray sensitive means located between the upper and lower gamma ray sensitive means in a vertical direction, and using the reading from said intermediate gamma ray sensitive means as said output signal.

In one form of the method the intermediate gamma ray sensitive means is moved until its output signal is the average of the two reference readings. In another form said output signal is integrated to locate the level at which the rate of change of the output signal's characteristics is at a maximum.

The present invention also provides a method which comprises taking readings from multiple static gamma ray sensitive means located at different levels and each of which detects the gamma radiation from a specific zone of the furnace.

### BRIEF DESCRIPTION OF THE DRAWINGS

For a better understanding of the present invention, and to show how the same may be carried into effect, reference will now be made, by way of example, to the accompanying drawings in which:—

FIG. 1 shows a radiation detecting device adjacent a furnace;

FIG. 2 is a pictorial view of the radiation detecting device; and

FIG. 3 is a diagrammatic vertical section through the radiation detecting device of FIG. 2.

### DETAILED DESCRIPTION OF THE DRAWINGS

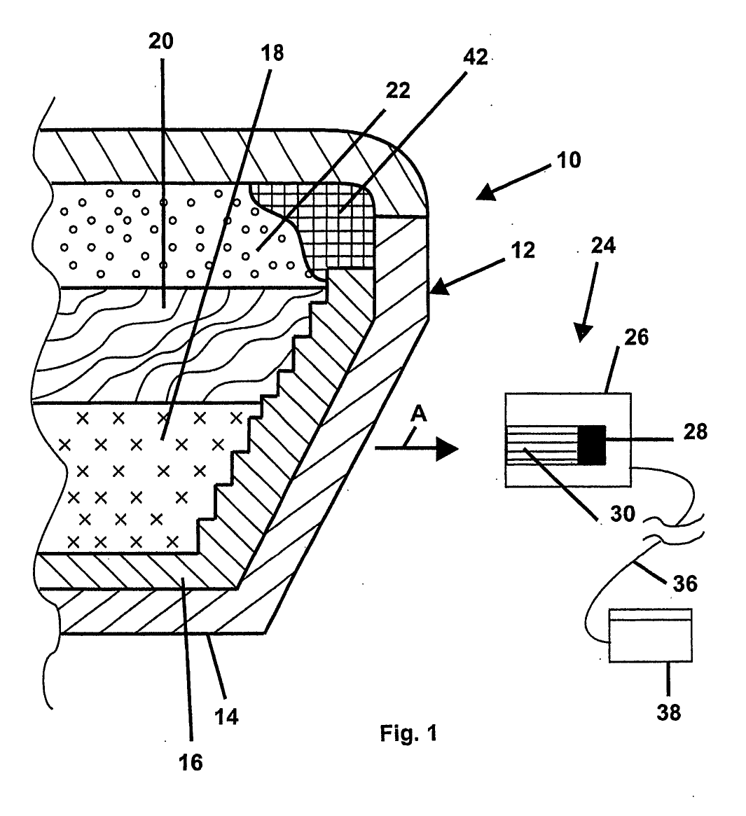

The furnace 10 illustrated in FIG. 1 is shown in vertical section and comprises a furnace wall 12 consisting of an outer wall 14 of thick metal and an inner lining 16 of refractory brick. In furnaces producing raw metals such as pig iron there is usually a layer of molten metal designated 18 at the bottom of the furnace, a layer of slag designated 20 above the metal, and an upper zone 22 which is filled with hot gasses. In some processes the most valuable materials are in the metal 18 and in others the most valuable materials are in the slag 20.

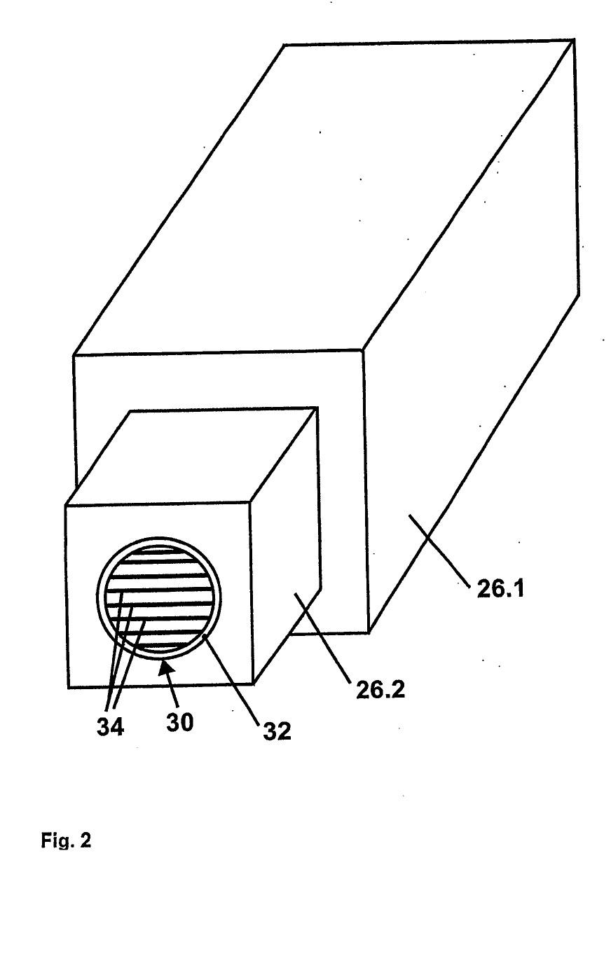

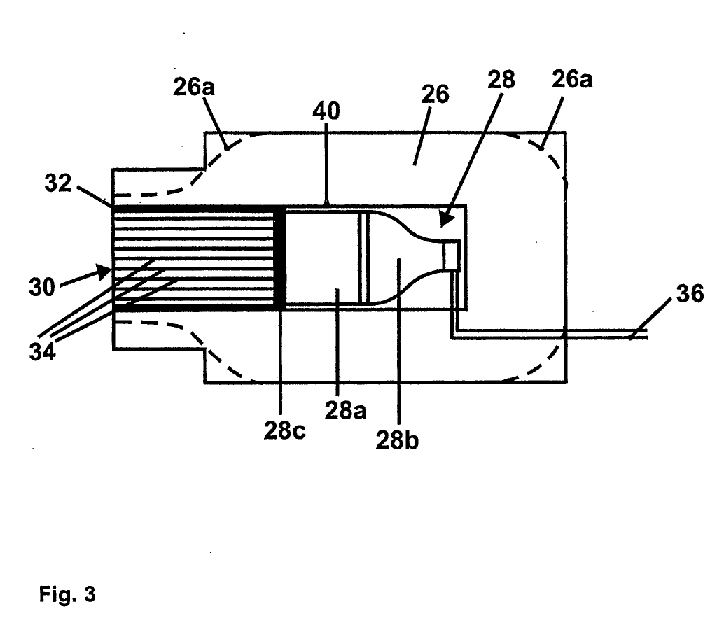

Reference numeral 24 designates a radiation detecting device which comprises an outer shield 26 (see FIGS. 2 and 3) for preventing stray gamma-rays from reaching a gamma ray detector 28 which is within the shield. The shield 26 can be of lead or any other high density material. In FIG. 2 the shield is shown as comprising two blocks 26.1, 26.1. In FIG. 3 lines 26a show another possible shape for the shield which achieves the same result but uses less lead.

In the form illustrated in FIG. 3 the gamma ray detector comprises a crystal 28a, a photo multiplier tube 28b and a metal plate 28c which shields the crystal from low energy photons.

The cavity which receives the detector 28 is lined with a steel, preferably a “Nu-metal”, sleeve 40. This prevents stray magnetic fields from interfering with the operation of the photo multiplier tube 28b.

The detector 28 can be a gamma ray spectrometer or a gamma ray radiation counter or both operating in unison. An example of a commercially available detector is the combination of a Nal (Sodium Iodide) scintillator coupled to a PMT (Photo Multiplier Tube). A PMT requires a stable high voltage power supply. Signals from a PMT must be amplified and electronically sampled. Usually an analogue to digital convertor is used to sample the amplified signal and make it available to the computer.

The PMT of a gamma ray radiation counter counts the flashes which are created, the so-called “scintillation”, as the photons enter the sensing crystal of the detector. Thus the output is simply the number of flashes counted, and the characteristic of the gamma ray emissions being detected is the rate at which impacts occur.

A gamma ray spectrometer on the other hand provides more detailed information including energy levels as well as the number of impacts. This information is usually displayed on a histogram. Thus the characteristics of the gamma ray emissions being detected are thus both energy and the rate at which impacts occur.

A collimator 30 is configured such that only those gamma ray photons which enter the collimator horizontally and from a predetermined zone can reach the detector 28. The collimator comprises a tube 32 mounted within the shield 26, there being, within the tube 32, a series of parallel, spaced apart, horizontal plates 34. The plates and tube form a series of parallel passages leading to the detector 28. This ensures that only gamma rays entering the passages horizontally and generally parallel to the axis of the tube 32 can reach the detector 28 (see arrow A in FIG. 1). The effect of the collimator is that line of sight from the detector 28 covers a horizontal strip-like zone of the furnace wall.

The device 24 is mounted on a support structure (not shown) which enables the device to move vertically or both horizontally and vertically. The support structure can be of any suitable type. For example, a conveyance that can be moved laterally is suitable, and preferably the conveyance can be moved completely around the furnace. The conveyance can be wheeled and run on rails that encircle the furnace. The wheels can be flanged. The detector 24 is mounted on the conveyance for vertical movement. The means for causing vertical movement can be, for example, a screw jack, a winch and cable, a pneumatic cylinder, an hydraulic cylinder or a combination of these. In another form the mounting means can be static and the detector can move horizontally on it.

The output from the detector 28 is fed along a communications cable 36 to a computer 38 which evaluates the signals received from the detector 28. A stand-alone computer with screen, keyboard, mouse etc can be used or alternatively, the computer can be an embedded computer which is within the detecting device 24 itself.

When the furnace is in operation, the molten metal and slag in the furnace emit gamma rays as does the hot gas above the slag. The radiation levels from the hot gas are low compared to those from the slag and molten metal. The radiation is because of the presence of radio-isotopes such as U238, U235, Th232 and Ra226 (Uranium, Thorium and Radium) and their decay products (sometimes called daughter products) some of which emit gamma rays. Of course, the material when charged cold into the furnace also emits gamma radiation. However, because of the distribution of the charge of the furnace, no usable information can be obtained. It is only when stratification takes place that usable results arise.

The intensity of the gamma ray emission varies with the quantity of radioactive material present. The slag and molten metal contain different quantities of radioactive materials and thus the radiation's intensity and the spectral characteristics of the radiation from the slag and metal differ. This difference although small is sufficiently great to result in the output of the detector 28 being detectably different when radiation is being received from the slag as opposed to when radiation is being received from the molten metal. Likewise the intensity and characteristics of the gamma rays radiating from the gases in zone 22 differ from that of the slag and molten metal.

In use, to find the interfaces, the detecting device 24 is moved vertically adjacent the furnace. The collimator is “pointed” at the furnace wall and only gamma rays emerging from a horizontal slit-like zone of the furnace wall can reach the detector through the collimator. Whilst the collimator 30 is only permitting horizontally travelling gamma rays emitted by the molten metal 18 to reach the detector 28, the output of the detector 28, as evaluated by the executable program loaded on the computer, will give a particular result. When the horizontally travelling gamma rays emitted by the slag are being received, the output from the detector 28 will be different. The change over from one result to the other indicates where the interface is between the slag and the molten metal. Likewise the interface between the slag and gasses above the slag can be detected.

An accurate knowledge of where the various interfaces are at a particular moment in time enables the furnace to be operated more efficiently and with greater safety.

In the above example of the invention a single detector is used. It is, however, possible to use two or more detectors to monitor emissions from two or more zones of the furnace. One advantage of having several detectors is that by using the output signals from all of them, the need to move detectors vertically is minimised.

In one specific arrangement a fixed upper detector is pointed at a zone of the furnace at which slag can be expected to be present. A fixed lower detector is likewise pointed at a zone which can be expected to have molten metal in, it. Readings are taken from these two detectors to provide reference signals representative of the current radiation intensities at these levels. A third detector is positioned midway between the fixed detectors and a reading taken. If the output from the third detector is closer to that of the upper detector that it is to that of the lower detector, then it is reading slag and not molten metal. It is therefore lowered to a position midway between its previous position and the lower detector. A further reading is taken. Depending on the reading obtained, the third detector is moved halfway towards the lower detector or halfway back to its previous position and another reading taken. This procedure continues until a level is found at which the reading of the third detector is the average of the readings of the upper and lower detectors. This indicates where the interface is.

The output of the third detector can be used in the form of a single value. Alternatively the signal can be integrated and a signal representative of the rate of change of intensity can be derived to locate the interface.

It is also possible to have a vertical array of multiple static detectors each reading the radiation from a specific zone of the furnace. By this means continuous monitoring of the interfaces becomes possible.

In another form one detector per “alarm level” is employed so that the furnace operators are notified when the interfaces in the furnace reach predetermined levels. The alarms can be, simply by way of example, a “stop feeding” alarm, a “stop tapping” alarm and a “start tapping” alarm.

In FIG. 1 reference 42 denotes the so-called banks which build up around the zone 22. The thickness of the banks is important to the way in which certain furnaces are controlled.

By moving the detector 24 horizontally, it is possible to sense the radiation from the banks, as opposed to the radiation from the zone 22, and thus obtain an indication as to the thickness of the banks.

1. A radiation detecting device for determining the conditions subsisting within a furnace, the device comprising gamma ray sensitive means for producing an output signal which varies in dependence on the characteristics of the gamma rays which said gamma ray sensitive means senses, means defining a path along which gamma rays emanating from a predetermined zone of said furnace can pass and impinge on said gamma ray sensitive means, and a shield for blocking gamma rays travelling towards said gamma ray sensitive means other than along said path.

2. A device as claimed in claim 1, where the path defining means includes a plurality of horizontal, spaced apart, parallel plates within a tube.

3. (Cancelled)

4. (Cancelled)

5. (Cancelled)

6. (Cancelled)

7. A system comprising three devices as claimed in claim 1, the devices being spaced apart in the vertical direction, the top and bottom devices being fixed and providing reference signals, and the centre one being movable vertically and providing said output signal.

8. In combination, a device as claimed in claim 1 and a mounting means for the device, the device being movable vertically on the mounting means.

9. The combination of claim 8, wherein the mounting means is mobile and can move horizontally with respect to the furnace.

10. The combination of claim 8, wherein the device is mounted so that it can move horizontally on the mounting means.

11. In combination, a device as claimed in claim 1 and a computer programmed to receive and analyze said output signal and produce a reading indicative of a change in the characteristics of the gamma rays impinging on said gamma ray sensitive means.

12. A method of determining the conditions subsisting within a furnace, the method comprising permitting gamma rays emanating from a predetermined zone of said furnace to impinge on a gamma ray sensitive means and generate an output signal which varies with the characteristics of the gamma rays impinging thereon, blocking gamma rays traveling towards said means other than from said zone, and analyzing said output signal to detect changes in the characteristics of said gamma rays.

13. A method as claimed in claim 12, wherein said zone is elongate in the horizontal direction and narrow in the vertical direction.

14. A method as claimed in claim 12, and comprising moving said gamma ray sensitive means vertically with respect to the furnace thereby to vary the position of said zone for the purpose of detecting interfaces between materials in the furnace.

15. A method as claimed in claim 12, and comprising moving said means horizontally with respect to the furnace thereby to vary the position of said zone for the purpose of determining the thickness of banks in the furnace.

16. A method as claimed in claim 12, and including the steps of taking reference readings from upper and lower gamma ray sensitive means, moving an intermediate gamma ray sensitive means located between the upper and lower gamma ray sensitive means in a vertical direction, and using the reading from said intermediate gamma ray sensitive means as said output signal.

17. A method as claimed in claim 16, and comprising the step of moving the intermediate gamma ray sensitive means until its output signal is the average of the two reference readings.

18. A method as claimed in claim 12, and including the step of integrating said output signal to locate the level at which the rate of change of the output signal's characteristics is at a maximum.

19. A method as claimed in claim 12 and comprising taking readings from multiple static gamma ray sensitive means located at different levels and each of which detects the gamma radiation from a specific zone of the furnace.
